(19) United States
(12) Patent Application Publication
(10) Pub. No.: US 2006/0195562 A1
(43) Pub. Date: Aug. 31, 2006

(54) System, software, and method for managing obsolescent high-technology inventory

(76) Inventors: Henry Eisenson, San Diego, CA (US); Christopher Chapin, San Diego, CA (US)

Correspondence Address: CATALYST LAW GROUP, APC, 9710 SCRANTON ROAD, SUITE S-170, SAN DIEGO, CA, 92121, US

(21) Appl. No.: 11/345,810

(22) Filed: Feb. 1, 2006

Related U.S. Application Data
(60) Provisional application No. 60/756,757, filed on Jan. 6, 2006.
(60) Provisional application No. 60/648,906, filed on Feb. 1, 2005.

(51) Int. Cl. G06F 15/173

(52) U.S. Cl. 709/223

(57) ABSTRACT

A Business Method by which otherwise independent nodes of a distribution system can undergo confidential interactions via an internet website or other means to equalize inventory to their mutual benefit and profit, with the Business Method Practitioner operating the mechanism and retaining a percentage of each transaction as a fee for the service provided. In the manufacturing world for which the Business Method is primarily intended, this has the collateral benefits of reducing the percentage of overstock goods sold at a discount and understock goods purchased at a premium, raising the overall profitability of the industry served, protecting branding, and improving performance of individual nodes of the market and of the overall market.

### RELATED APPLICATIONS

This application claims priority to U.S. Provisional Application No. 60/648,906, filed Feb. 1, 2005; U.S. Provisional Application No. 60/756,757, filed Jan. 6, 2006; PCT Application, Attorney Docket No. 8099-003-WO, Entitled: Inventory Equalization System, filed Jan. 27, 2006. The disclosure of the above referenced application is incorporated by reference in its entirety herein.

### FIELD OF THE INVENTION

The present invention relates generally to the field of product inventory control, where imperfect stocking or manufacturing decisions can result in accumulations of excess inventory at some points and deficiencies of inventory at other points. The present invention provides systems and methods by which users can cost-effectively and profitably equalize inventory, facilitating the movement of items from geographic markets and participating nodes in which they are slow-moving to geographic markets and participating nodes in which they are faster moving.

### BACKGROUND OF THE INVENTION

There exists a spectrum of methodologies by which inventory is managed by companies with multiple outlets, distributors, wholesalers, retailers, and manufacturers, with multiple distribution points, all intended to improve profitability of the overall system optimizing the relationship between the cost of maintaining inventory and the revenue generated by that inventory. The systems and methods of the prior art attempt to manage inventory by forecasting and optimizing movement of inventory from manufacturer to consumer. These inventions are directed towards such things as systems and methods for managing the rate of use of inventory by a supplier and calculating therefrom the proper time for ordering more inventory. Also, systems and methods for managing variable priced inventory, e.g., travel services, using a multi-layered SKU system. And, systems and methods for moving inventory from storage to the sales floor before the storage cost per item causes the retailer's profit to significantly diminish.

U.S. Pat. No. 6,643,626, issued to Perri de Resende and titled Sales Point Business Method and Apparatus, generally describes remotely monitoring a display case having merchandise. The described purpose for remotely monitoring the display case is to assure that authorized users are accessing the merchandise, to monitor transactions involving the merchandise, and/or to provide security against theft, fire and other hazards. This invention allows for the remote monitoring of merchandise to detect the depletion of the merchandise, whether by desired or undesired means. The invention does not provide a means for managing the merchandise inventory amounts.

U.S. Pat. No. 6,405,177, issued to DiMattina and titled System for Securing Commercial Transactions Conducted On-Line, generally describes a system and method allowing on-line retailers to offer guaranteed financial services in addition to their goods. The financial services are such things as secure credit card transactions, price guarantees, guaranteed delivery and return policies and implied warrantee guarantees. The system for accomplishing this method comprises a purchaser-retailer transaction means, a single action (“one click”) component, and a means for sending the financial services certificate to the purchaser. While this patent is related to selling a retailer's inventory, it in no way is capable of managing inventory.

United States Patent Application No.: 2005/0075945, by Matsumoto et al. and titled Inventory Management and Ordering System, and Ordering Management System Using the Previous System, describes a system for managing a business's inventory. The system monitors the quantity of an item in inventory and the rate of use is determined so that future order dates can be predicted. Orders are placed based on the forecast, thereby keeping an adequate supply of an item. While this invention recognizes the need for inventory management, it focuses only on timely ordering of supplies to maintain an item on hand. The dynamics of inventory management being much more complex than striking a balance between use of goods and ordering of goods, this invention is limited to only a small sub-set of inventory management.

United States Patent Application No.: 2003/0036981, by Vaughn et al. and titled System and Method for Managing Inventory, describes a method and system wherein a retailer provides available inventory to a server and a potential consumer can shop the inventory from the server. The invention is that the inventory, which is related to travel, is defined in the travel server by SKU group, record and unit. These different levels of SKU are necessary with travel-based inventory, which is unique inventory. For example, the price of a single travel-based good can vary based on how far in advance the good is purchased. This invention provides a means for accounting for such variance in goods price. The retailer provides information for the SKU levels on available inventory, and the potential consumer searches for specific products based on a query that is addressed and processed at the SKU levels. The server matches the two. This invention manages inventory by providing a specific means to shop for travel based goods.

United States Patent Application No.: 2005/0033666, by Kurashige and titled Inventory Management Method and Program Product, generally describes a management server having an inventory database, a purchase database and a sales database. The server is designed to track certain inventory indicators and uses these indicators to move goods from inventory to sales. By tracking these indicators, inventory that is kept in storage can be moved to sales before the cost of the storage factored into each good diminishes the profits. It is desirable to keep products flowing from storage to the sales floor and in turn out the door. But, this patent does not address the problem of inventory that does not sell or inadequate inventory to meet demand.

United States Patent Application No.: 2005/0004831, by Najmi et al. and titled System Providing for Inventory Optimization in Association with a Centrally Managed Master Repository for Core Reference Data Associated with an Enterprise, describes a system and method for developing an inventory plan for a supply chain. The supply chain is defined as the chain of participants beginning with suppliers including the manufacturers and vendors and ending with the consumer. The inventory plan is an optimized plan that assures that the members of the supply chain are able to predict proper inventory amounts based on a variety of defined metrics. If metrics reach a critical/problematic point, the plan is adjusted to account therefor. New metrics can be added. This invention recognizes and addresses the problems with overstock and understock in a supply chain and attempts to develop a dynamic inventory plan that will prevent the occurrence of these problems. However, given the unpredictable nature of the consumer, this invention cannot address inventory problems that arise from an unexpected change in consumer demand.

When a manufacturer in the technology sector plans the production of a product, it is generally the marketing group that defines the production quantity either from market estimates or from orders by customers. A specific end-product manufacturing quantity is one of the factors upon which the production plan is based and prescribes the quantity of each of the components to be ordered.

The production engineering effort results in a manufacturing procedure, quality management methods, and—of critical importance—a Bill of Materials (BOM). The BOM tells the procurement function (subcontracts manager or buyer) what parts are required and how many of each part to acquire. Some overage is planned to accommodate production engineering, losses in production, and subsequent repairs, resulting in a specific order quantity to be absorbed by the program.

Some of the required parts will be “vendor-standard,” selected from catalogs by the manufacturer's part number. The price paid for each of those standard parts will vary based upon the quantity purchased. Unit price may change by as much as an order of magnitude as quantity varies from a few to 10,000 pieces or more. It is not uncommon for 9,200 pieces of a part to cost more than 10,000 pieces of the same part.

It is therefore customary for the manufacturer to estimate parts absorption for the production process, add losses and failures, and add a factor for long-term repairs. This practice reduces the risk of shortages, which can cause expensive problems when the part involves a long lead time and/or high low-quantity unit prices. It is common for a requirement for 9,200 pieces to be met by placing an order for 10,000 pieces.

When the vendor-standard parts arrive, each has been stamped with either the part manufacturer's standard part number, or—if quantity justifies and the customer requires it—a customer-specific part number.

Some requirements cannot be met by catalogued vendor-standard parts, but require the design and production of custom parts. In addition, some parts incorporate special intellectual property of the customer and therefore must be produced to order. When these parts reach inventory, they are not marked with the standard part number of the manufacturer of the part, but carry a special part number usually unique to the program that will use them.

Often, a custom integrated circuit will include several functions, of which some can be wired into a circuit and used while ignoring others. Some functions are of such complexity that they are difficult or nearly impossible to reverse-engineer without assistance, so there is no risk to proprietary information building and selling products that incorporate such parts. Similarly, a multi-purpose custom integrated circuit can be used for some non-proprietary function while ignoring proprietary functions that are built into it. This often occurs even in the case of end-products by the owner of the integrated circuit and of the intellectual property; a product line with several tiers of functionality might omit some functions in the less expensive versions by simply omitting the wiring to the chip connections that provide those functions.

Thus, there are at least three types of parts that exist. First, a “standard” part, listed in the catalog of the part producer, carrying the logo of the part producer, consistent with the specifications published by that producer. Anyone looking at the part number can refer to the part number and the catalog and be certain as to the characteristics of the part. Second, a “standard” part, listed in the catalog of the part producer, consistent with the specifications published by that producer. It carries a special part number rather than its standard part number, and may or may not carry the logo or name of the producer of the part. Anyone given the equivalent standard part number and the producer of the part can refer to the appropriate catalog and be certain as to the characteristics of the part. Finally, a “custom” part, designed and produced in accordance with specifications set by the manufacturer ordering the part and met by the producer of the part. There is no catalog or part number equivalent that can be used to determine the performance or characteristics of that part, but the part carries a customer's unique part number.

Inventory excess affects all levels of the parts acquisition and inventory management by distributors, wholesalers, retailers, service providers, and manufacturing companies including, but not limited to companies that manufacture product or subcontract production. Inventory excess is expensive, and many companies have developed business methods for dealing with the problem. There are two possible solution categories. The first is to control order quantities to prevent or minimize surplus parts, and the second is to develop means by which surplus parts are sold at a price and volume that (1) recovers cash and (2) at a time, price, and volume that satisfies auditors so the impact of obsolescence upon financial statements is minimized.

Some companies order precise quantities. The problem with this approach is that it increases the unit price and raises the cost of doing business, thus reducing the competitive position of the project and the company that orders parts in this manner, and the higher cost is amplified when a later insufficiency arises and a still higher cost must be paid to buy smaller quantities at that later date.

Some companies place orders and negotiate subcontracts such that overages can be returned to the vendor. There are several potential problems with this ordering strategy. The vendor may not be willing to accept returns. The vendor may impose a restocking charge that raises the per-unit cost of the parts used. If the retained quantity crosses into the next volume discount column, the per-unit cost can rise very substantially (in addition to restocking charges). If the part is a custom part, with a customer part number, the vendor will not accept returns in any case.

The company holding obsolescing parts resulting from a complete production project can instruct engineers working on subsequent projects to include as many of those parts as possible in the new design, in an attempt to establish inventory usage. The problem with this approach is that the motivation to use those parts is purely financial, and may drive the technical group in directions that are not technically optimum and/or do not meet goals set by the marketing group.

The company holding obsolescing parts may direct its engineering group to use surplus parts for R&D, thus absorbing some of them from inventory. The problem with this approach is that in most cases the number of parts used will be too small to materially affect the gross financial effect of obsolescence of the parts remaining in inventory. There will then be claims of “usage” by the company, and of “obsolescence” by the auditors, leading to argument, negotiation, and compromise that saps resources and potentially injures the relationship, particularly when the impact of obsolescence is critical to the achievement of financial targets.

The company holding obsolescing parts can ask the sales representative that originally sold the parts to the company to seek a buyer for them. The problem with this approach is that the sales representative's loyalty is to the company that employs him, and that company seeks new customers for its products. There is little motivation for a representative specializing in sales of new parts to develop a secondary market for surplus parts. The sales representative that complies with such a customer request can jeopardize employment.

The company holding obsolescing parts can aggressively market some percentage of them to surplus dealers in an attempt to achieve a price that will permit a higher valuation in inventory for parts that do not sell, thus establishing “usage” through sales, and reducing the impact of obsolescence upon financial reporting. The problem with this approach is that surplus dealers are experts in obsolescence, know that by waiting the parts valuation will decline to near zero, and are not motivated to pay a higher price a few months earlier except in the rare cases in which they may have identified a specific customer for a specific part. That is not a general solution.

The company holding obsolescing parts can seek new buyers via some other channels that permit price support, such as the opening of a wholly-owned surplus outlet. The problem with this approach is that this puts that company into a new business for which it is probably not configured, staffed, or funded, and the establishment of such a new business center may be more costly than the money it saves. This is also true if the surplus outlet is jointly owned by more than one company generating obsolescent parts.

The company holding obsolescing parts that were initially custom made for a particular application, or are a standard part but are imprinted with that company's logo and/or part number instead of an industry-wide part number, can seek surplus buyers for the part and try to explain to them the characteristics of the part or the standard part equivalency, in hopes of raising perceived value. The problem with this approach is that this raises the complexity of that transaction, and of subsequent transactions, for the surplus dealer, and the cost of that additional complexity may be higher than any likely increase in perceived value.

For all these reasons and more, all components of the system including manufacturers, wholesalers/distributors, and retailers seek ways and means to relieve the excess inventory problem.

A solution to a deficiency in inventory is to place an order for more. At the large company level that solution is sometimes impractical. When the original imperfection in judgment resulted in one or two items selling out earlier than expected, or the unplanned success of a particular style or color of an item, it may not be cost-effective to place a re-order if there are often minimum order quantities, or penalties when orders are below some threshold. Some items, in fact, may be orderable only in arrays that consist (as an example) of one gross of each color. When an item sells out in the two colors of a local university, for example, it may not be cost effective to order twelve gross, ten gross of which will languish along with the original shipment. In many such cases, the deficiency remains unsatisfied because there is no method by which the order can be filled cost-effectively.

In addition, many times deficient parts are custom manufactured for a specific company. The custom parts are not the typical parts order from a company due to the specific and unusual requirements. Therefore, the cost of these custom parts is very high. The cost for the company with the deficient parts to re-order additional custom parts is very expensive.

Further, re-order items may not be available at the factory or distributor level because they are back-ordered, closed out, or discontinued, resulting in lower profitability for the company whose inventory is comprised of partial size runs or limited color options, etc., making the product difficult to sell.

When all components of a distribution network are members of the same system, and all are interconnected by inventory management software, communications, and logistics mechanisms (shipping), companies can devise software to (1) recognize inequities, (2) react to trigger points, (3) make recommendations to management, (4) monitor the logistical implementation of solutions, and (5) create data structures that suggest improvements to ordering protocols that lessen the likelihood of repetitive problems. This is a method by which organized distribution systems can be optimized to reduce obsolescence, minimize investment in inventory, improve overall profitability, protect branding, and maintain brand franchises.

At the other extreme, a company with a franchise to sell protected branded merchandise will load excess merchandise onto a truck at night and ship it to another outlet, unauthorized by the brand manager, and despite any obligation to not do such.

Between these two points exist many different potential solutions, of which none work sufficiently to satisfy the preponderance of the problems in the real world marketplace.

One problem with many existing inventory management systems is that they report to management when a given monitored item reaches a re-order level at a given location or storage point, but do not compare levels of different locations or storage points and report comparative levels.

Another problem with existing inventory management systems that monitor inventory levels at multiple sites is that they are not constructed to consider the value of the equalization of inventory between nodes (locations, or storage points, or distribution points).

Another problem is that many such systems do not provide a mechanism to ensure customer confidentiality of a part's technical specifications between the companies of the inventory transaction.

Another problem is that many such systems do not provide a mechanism to recognize the cost of an overstock at one point, with aging and obsolescing inventory, with a simultaneous understock at a second point, with loss of sales due to non-availability.

Another problem is that many such systems that do provide a mechanism that recognizes the importance of differential inventory levels, due to geographic preferences or errors made in placing orders, usually stop re-orders of obsolescing inventory and increase orders of understocked inventory, thus correcting the imbalance over time but in the least profitable manner.

Another fundamental problem with all such existing inventory management systems is that they apply exclusively to members of an integrated organization and not to transients or otherwise unaffiliated business units, and therefore the beneficiaries of such systems are only those who are part of that organization. For example, such a system that addresses the national distribution of product X might have the potential to do so for the organization that “owns and operates” the system, but not for the sole-site business that might benefit from its use, even if that sole-site's participation might assist the organization that operates the system by reducing its logistics costs.

While many of the prior art inventory management and equalization solutions may be suitable to one degree or another for the particular limited requirements they address, they are not optimum or generalized solutions for broad and diverse multi-node retail, wholesale, manufacture, and distributor markets, do not meet the needs of transients passing through the system to satisfy inventory imbalance requirements, and are not sufficiently flexible to be adaptable to the needs of many potential users.

### BRIEF SUMMARY OF THE INVENTION

In view of the foregoing disadvantages inherent in the known methods, tools, and practices for the management of inventories and the efficient sale, transfer, and subsequent utilization of obsolescent/surplus inventory of technology parts, the present invention provides a substantial divergence from custom and improvement over prior art and management techniques to satisfy the needs of both those companies holding inventory that has become “obsolescent” (primarily in financial terms and solely with respect to those companies), and other companies that seek to purchase such parts, to the benefit and enhanced profitability of both.

The main objective of the present invention is to provide a cost-effective system comprised of software and a business method by which multiple entities, geographically diverse and each managing its own inventory by conventional means, can efficiently broadcast the availability of parts or technical specifications of parts that have accumulated in excess at some points and that are needed at others, then provide confidential automated matching of overstock items to understock requirements, thereby stimulating transactions to the benefit and profit of both parties.

Another objective is to provide a common online website on which, by automated or manual means, companies holding obsolescing inventory (or inventory that is about to begin entering that status) can list the inventory for sale, by vendor-standard part number.

Another objective is to permit companies seeking to purchase inventory to visit that common online website on a confidential basis and list their requirements by vendor-standard part number.

Another objective is to permit potential sellers to list, on a confidential basis, inventory for sale that was a vendor-standard part, but marked with a customer part number rather than a vendor-standard part number, with stated equivalency to permit potential buyer matches.

Another objective is to permit potential sellers to list, on a confidential basis, inventory for sale that was not a vendor-standard part but a full-custom part developed for the seller's specific program, such listing to be in the format of a table of specifications that permits the present invention's software to match those specifications with requirements of potential buyers, thus permitting a secondary market in custom parts that are not standard and for which no specifications have been published.

Another objective is to permit potential sellers of multi-function custom parts to list, on a confidential basis, them in a manner that permits the disclosure of pre-determined separately usable functions, giving them the option of withholding the description of functions or capabilities that may contain proprietary information while disclosing separately addressable functions that may have value to purchasers.

Another objective is to permit potential buyers to disclose only the separately usable functions required to ensure a complementary match, thereby allowing the potential buyer to maintain confidentiality on the separately usable functions not required to ensure the transaction.

Another objective is to require potential buyers via an authorization step to agree not to reverse engineer a part acquired from the seller.

Another objective is to provide software that converts all inventory for sale, whether vendor-standard or full-custom, to a table of specifications that permits accurate matching to the requirements of potential purchasers, thus reducing all inventory for sale to a common denominator of technical functionality rather than part number alone.

Another objective is to provide software that describes multi-function custom parts in a manner that permits potential purchasers to buy them based upon separately usable functions, giving buyers the option of disregarding unnecessary functions while enabling valuable ones, simply by wiring.

Another objective is to insulate potential sellers from the parts they offer for sale, in those cases where the performance of such parts may characterize the system(s) utilizing them and jeopardize corporate-confidential and proprietary information.

Another objective is to permit potential buyers to list requirements in the form of a table of specifications, to permit the present invention's software to match those specifications with the requirements of potential sellers, thus permitting a secondary market in all parts, including custom parts that are not standard and for which no specifications have been published.

Another objective is to insulate potential buyers from the requirements they offer to buy, in those cases where the performance of such parts may characterize the system(s) utilizing them and jeopardize corporate-confidential information.

Another objective is to provide to such sellers of “obsolescing” inventory and such buyers of required inventory a convenient, efficient, economical, and (potentially) confidential secondary online market for such transactions, as a website on which both overstock and understock conditions are listed either manually or automatically (by customer inventory management software, if so enabled).

Another objective is to provide users of such an online web-based system with a communication methodology that is rapid, efficient, secure, confidential, and accurate, advising them of potential matches between desired sales and desired buys of inventory.

Another objective is to provide software that operates “behind” the website, automatically qualifying entrants, guiding them regarding data entry, establishing automated communication, assisting in validating overstock and understock listings, and providing technical support.

Another objective is to provide a software system that automatically evaluates all listings and to the maximum practical extent converts them to a standard format to facilitate comparison.

Another objective is to provide a software system that examines parts and requirements listed in accordance with the aforementioned standard format, and makes matches between overstock and understock conditions, using some combination of part numbers, part number equivalencies, specification tables, and quantities.

Another objective is to provide a software system that assembles BUY listings such that the aggregate absorbs the maximum practical quantity of parts in a given SELL listing in the fewest possible number of transactions.

Another objective is to provide a software system that automatically notifies participants when matches are detected, and guides them through the completion of a transaction while withholding the identity of the parties, one from the other.

Another objective is to provide a software system that automatically completes transactions when participants provide the system with that latitude; that is, when the system has been “permitted” to make and accept deals in behalf of participants to reduce administrative overhead involved in the usage of the present invention.

Another objective is to provide a software system that can automatically initiate a transaction when a defined opportunity to buy or sell arises and the software system is notified accordingly, thus protecting the buyer or the seller that exercises that notification option of the most timely possible response and priority in meeting needs via the system.

Another objective is to provide a software system that can be automatically interfaced with the inventory management systems and/or the purchasing/procurement systems of participants, therefore permitting automated or semi-automated listings of overstock and understock conditions, and automated or semi-automated initiation of transactions by the inventory management systems and/or the purchasing/procurement systems of participants, if so configured and so enabled.

Another objective is to provide such an online brokerage and software system that profitably collects fees for the connection of such buyers to such sellers.

Another objective is to provide a software system that automatically collects data on such transactions and prepares useful reports that are commercially valuable and can be profitably sold.

Another objective is to provide an optional software module that can be added to the inventory management systems and/or the purchasing/procurement systems of participants which bypasses the website of the present invention and creates automatic emails among participants, disclosing overstock and understock conditions and supporting direct transactions between participants without the need for a central brokerage.

Another objective is to provide a cyclical chain of emails that a member's existing inventory management system can join to report inventory status, and exploit to initiate transactions, in a manual, automated, or semi-automated manner.

Another objective is to eliminate or reduce the need for a centralized brokerage that would conduct transactions and collect fees, achieved by enabling direct peer-to-peer communication and transactions.

Another objective is to allow for internet information interchange mechanisms whereby participants in the process can be publicly “graded” by peers, and comments exchanged, at no expense to any of them.

Another objective is to provide a software module that is compatible or can be made compatible with existing inventory management software products such that the software module is aware of inventory status.

Another objective is to provide such a system that permits management to establish controls and local criteria for various actions, such that the software module is made aware of management input and decisions. The system must be configurable to meet local operating conditions at each participating node.

Another objective is to provide the software module with a hardware interface to the each participant's internet communication system and ISP.

Another objective is to provide the all communication of the present invention, in all of its forms, with an automated encryption capability that will ensure confidence and security as data is transmitted over the internet.

Another objective is to provide a mechanism and system to accumulate product data, plus node ID, date, volume, and all other useful data, making such information available to selected components of the system including distributors, manufacturers, etc. Since such information is of commercial value it is expected to evolve into a revenue source for the implementer of the system.

Another objective is to provide a central bonded and anonymizing fulfillment service with the capability, for a fee, to protect the identities of sellers and buyers using the present invention, permitting inventory shipments to the service, removal of identifying packaging data, and re-shipping inventory to the intended recipient, with similar control over funds paid.

Another objective is to provide a mechanism and system that can be readily applied to other situations involving unforeseeable inequities of supply and demand, such as in manufacturing where one manufacturer has an abundance of a little-used raw material and another has a deficiency thereof, and both would benefit from equalization of their inventory if they knew of each other and were provided a cost-effective means for achieving a transaction.

It is the intention of the inventors that these objects apply equally to all situations applicable to any defined product category involving a centralized brokerage with a website on which participants list overstock and understock conditions, with a software engine that makes matches, manages communication, and supports completion of transactions, all for a brokerage fee.

It is the intention of the inventors that these objects apply equally to all situations involving a decentralized (hubless) peer-to-peer inventory equalization and transfer system applicable to any defined product category, characterized by (1) business entities with inventory surpluses, (2) automated or human entry of excess inventory and its characteristics in a cyclical internet message, (3) automated or human evaluation of “available” surpluses by the software modules at each node in the system, (4) automated or human comparison of “available” surpluses with local deficiencies, and (5) notification of management when a match is found by automated means, or automated closing of a transaction at the moment the system becomes aware a match has been found.

Other objects and advantages of the present invention will become known to the reader and it is intended that these objects and advantages be within the scope of the present invention.

To the accomplishment of the above and related objects, this invention may be embodied in the forms illustrated in the accompanying specification and drawings. However, the specification and drawings are illustrative of the basic concepts only; there are many possible configurations and derivatives lying within the intended scope of the invention.

### BRIEF DESCRIPTION OF THE FIGURES

FIGS. 1-9 depict preferred embodiments of the current invention showing the flow of information through the present invention, as it might be deployed in support of a random assembly of nodes (herein, as an example, manufacture establishments).

Various other objects, features and attendant advantages of the present invention will become evident to one of ordinary skill in the art given this disclosure. However, these alternatives and derivatives are well within the spirit of the current invention.

FIG. 1 depicts some number (four in the example) of otherwise unaffiliated, unconnected company, each subscribed to the operation of the current invention. Each company is referred to herein as a “Node.” In this FIGURE, the nodes are each numbered uniquely 12, 14, 16 and 18, and are collectively referred to as 101. Each node has six technical specifications including: category 13.1, subcategory 13.2, vendor 13.3, part number 13.4, basic specifications 13.5, and quantity 13.6. All nodes are communicating their status, including both overstock (available) and understock (sought) items to the invention inventory management system via the internet or other communication means. Therefore, the inventory management system has access to all reported overstocked and understocked items of participating nodes and each item is uniquely identified by technical specifications.

FIG. 2 depicts a sell listing 15 and a buy listing 13 for node 16 and node 12 respectively. The FIGURE shows a detailed representation of a sell listing 15 and a buy listing 13.

FIG. 3 depicts the interaction between the at least two nodes and the EPM 108. The at least two nodes present their technical specifications 22/23 or part numbers 20/21 to the EPM 108. The EPM 108 converts technical specification 22/23 and part numbers 20/21 to specification tables 24/25. The comparison step 200 compares all technical specification tables and connects complementary overstock technical specifications 24 with understock technical specifications 25. The communication means 106 then communicates a non-confidential complementary match to the at least two nodes.

FIG. 4 reflects a computational process within the EPM 108 in the invention, during which all communicated mis-stock information is compared. Complementary matches identified; a “complementary match” being an event in which one node has an under condition and another node an over condition of the same technical specification, and the understocked participant having authorization to sell the brand represented by the technical specification.

FIG. 5 shows a match report being made to each node of a possible transaction. At this point, the participants are preferably unknown to each other and might be geographically distant.

FIG. 6 shows payment (by any of many means) by the understocked node to the exchange processing means, which notifies the overstocked node to prepare to ship.

FIG. 7 illustrates disclosure to both participating nodes of the other's identity, address, etc.

FIG. 8 illustrates shipment of merchandise to understocked node, and transfer of funds/credit to formerly overstocked node via the inventory management system of the current invention.

FIG. 9 illustrates the basic embodiment of the current invention inventory management system 100 comprising at least two nodes 101, a communication means 106 and an exchange processing means 108.

### DETAILED DESCRIPTION OF THE INVENTION

As used herein, the term “mis-stocked” is applied to overstocked inventory and understocked inventory. Also, variations of the word may be used, e.g., “mis-stock” and “mis-stocking”.

As used herein, the term “node” refers to a manufacturer, retailer, distributor, wholesaler, corporation, company or other business entity dealing with inventory and desiring to manage inventory using the current invention. Preferably, the term “node” is a large company that manufactures or subcontracts the production of electronic parts or a large company that purchases electronic parts to be incorporated in the production of an additional part. The term “at least two nodes” refers to these same entities when using the invention system wherein there must be at least one overstocked entity and at least one understocked entity.

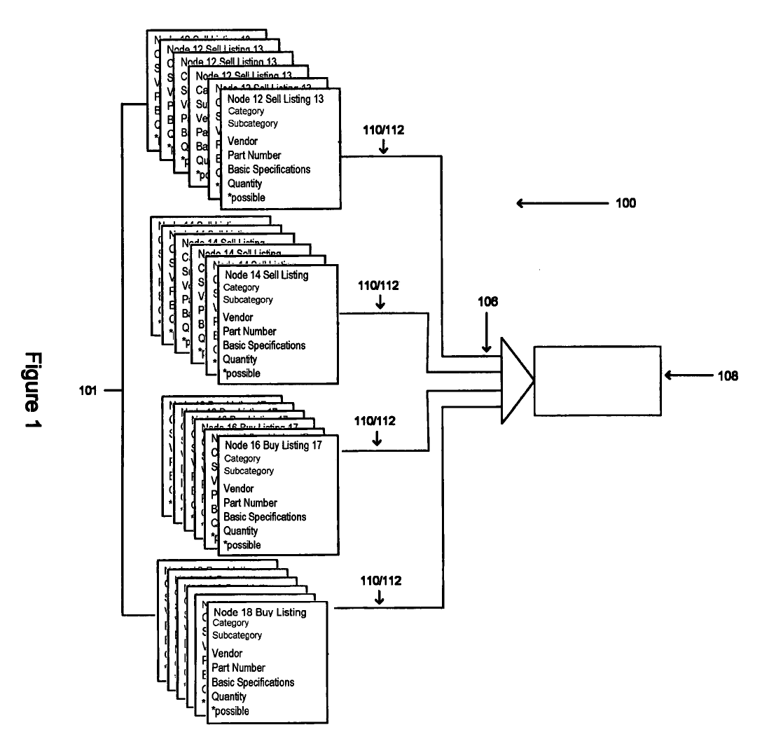

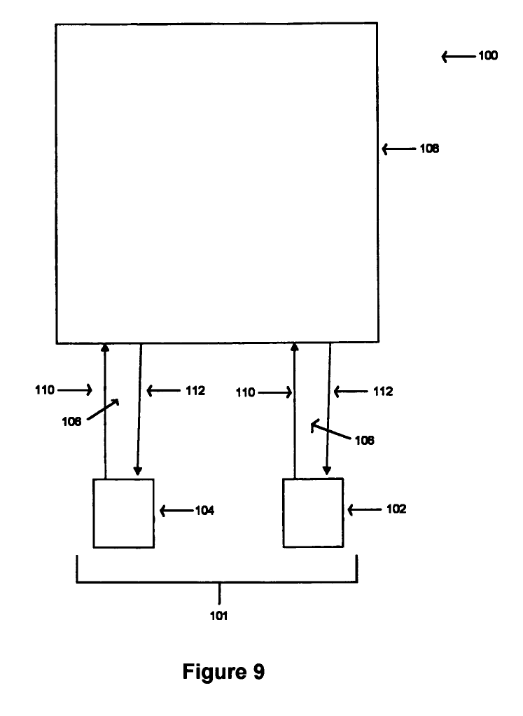

Turning to the FIGURES, one embodiment of the current invention system and method is described. In the preferred embodiment, the inventory management system (IMS) 100 comprises at least two nodes 101, a communication means 106, and a exchange processing means (EPM) 108. FIG. 9. The nodes (e.g., 12, 14, 16 and 18 of FIG. 1 or e.g., 102 and 104 of FIG. 9) comprising the at least two nodes 101 of the invention are preferably companies engaged in buy/sell of related products. For example, and as used herein, the companies are electronic parts companies. In addition to the company not being limited to the electronic parts business, the invention is also a useful management of inventory for the suppliers, retailers, distributors and other parties who are involved the supply chain of businesses involved in ultimately getting product to the consumer or an end user.

FIG. 9 communication means 106 comprises a means for transferring inventory information between nodes, 102 and 104, of the at least two nodes 101 and the EPM 108. In the preferred embodiment, the communication means 106 comprises both data input means 110 and data receipt means 112. Furthermore, the communication means 106 can be any of a variety of means, including, but not limited to, computer based communication, telephone based communication, and paper based communication. Still further, communication means 106 can be a computer and monitor linked to the internet. Those of ordinary skill in the art will readily employ these and other communication means with the current invention.

The communication means 106 preferably comprises a confidentiality means 203. The confidentiality means 203 permits the at least two nodes to choose to disclose all or part of the independently-addressable functions or multi-function parts listed. This permits the at least two nodes to withhold certain functionality that might jeopardize the security of proprietary information or intellectual property.

The data input means 110 and the data receipt means 112 will function in a way that suits the communication means 106 employed. For example, if the communication means 106 is a computer, then the data input means 110 is any means of data input that is compatible with a computer, for example, is a keyboard. Similarly, the data receipt means 112 is any means of data input that is compatible with a computer, for example a monitor or a printer.

It is notable that the IMS 100 can be configured to allow each node comprising the at least two nodes 101 of the system to have its own communication means 106. For example, node 104 can have a computer as the communication means 106, while node 102 can have a phone as the communication means 106. In this example, the data that is input via a computer from node 104 can be received via the telephone by node 102. This is a digital to analog (voice) conversion. Other data conversions include, but are not limited to, computer to paper (printer one direction, optical character recognition the other direction), and voice to computer (voice recognition software one direction, and voice over/voice readback software the other direction). Conversion of data from one to another communication means 106 is readily accomplished by those of ordinary skill in the art.

Data input to the inventory management system 100 should describe the inventory. This is inventory data and it typically describes a node's inventory and whether that inventory is overstocked or understocked. In its most basic form, the input data can be a description of the inventory drafted similar to an advertisement or a technical specification sheet. A query using terms within the description will produce the description. This means of data input and data retrieval is similar to the technology employed by search engines for finding web pages. Also similar to web pages, this means is inefficient in that a variety of tangentially related inventory descriptions having the query words will be produced and the user will have to manually review these documents for relevance. Similarly, by not using the proper search terms, inventory descriptions can be missed.

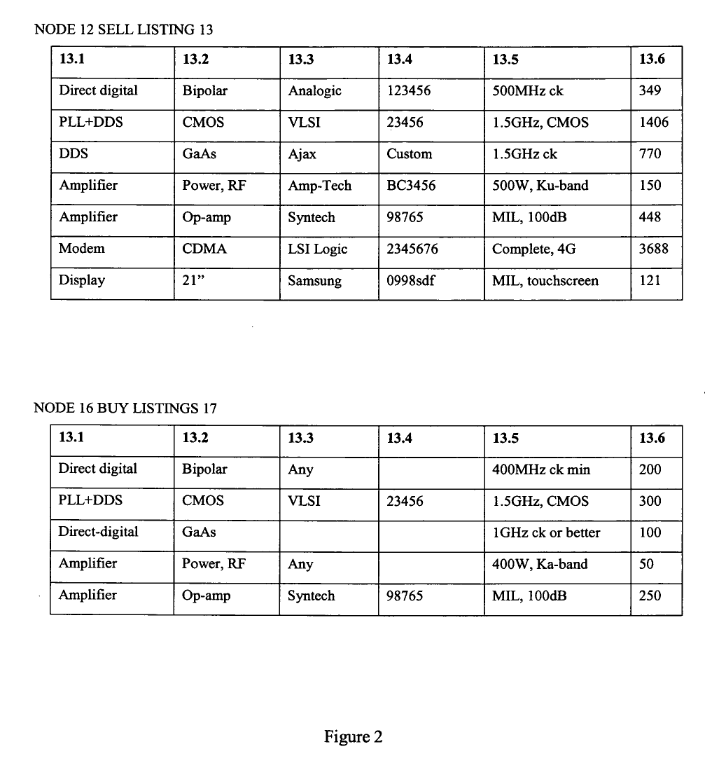

In the preferred embodiment, data input to and retrieved from the IMS 100 is described using vendor-standard part numbers, part number equivalents, custom part numbers, or technical specifications. Every standard part can be perfectly defined by a vendor-standard part number, if the part is so marked, because the vendor lists full specifications for each part number. Every standard part that has been stamped by a customer part number can be perfectly defined if a means is provided to correlate that number with the vendor-standard part number and the corresponding published specifications. Every custom part that was expressly made by a vendor to meet the customer's technical specifications can be accurately represented by a table listing such technical specifications, such table to be constructed in some standardized manner as to permit matching between tables of existing characteristics, and tables of desired characteristics. FIG. 2 shows the preferred embodiment in which a website is established and promoted on which sellers (holders of excess inventories of parts) and buyers can list technical specification surpluses and requirements either by vendor-standard part numbers, part number equivalents, custom part numbers, or technical specifications.

In the alternative, a stock keeping unit (SKU) or any unique identifier could be employed. The SKU standardizes the description of inventory so that the users quickly and efficiently query inventory in the system. SKUs are often times a series of numbers.

The EPM 108 of the IMS 100 is preferably in silico, and is most preferably a computer database. EPM 108 preferably comprises an inventory data storage means and an inventory data comparison means. EPM 108 further may comprise a complementary match ranking function for communicating the most relevant complementary match to one node of the at least two nodes. This is useful when there is more than one match of complementary inventory.

EPM 108 further may comprise a transaction management function for orchestrating payment and inventory shipping by and between nodes determined to have complementary matching inventory. In this embodiment, EPM 108 holds in memory all of the inventory descriptions. The EPM 108 also receives queries for inventory and then searches the inventory descriptions in memory, comparing the inventory query with the inventory database. Inventory and query matches are called complementary matches and are presented to the nodes 101 so that an inventory transaction can proceed.

In an alternative embodiment, the EPM 108 also guides the transaction following a query match with listed inventory. For example, node 102 inputs to EPM 108, via input means 110, technical specifications representing inventory that node 102 has as overstock. Node 104 inputs to EPM 108 via input means 110 a query for inventory using technical specifications for inventory that is understocked. EPM 108 receives the query and matches the query with the overstock stored in the database. EPM 108 then communicates the overstock inventory available to node 104 via the data receipt means 106. Node 104 can either accept or reject the presented overstock. Should node 104 accept the presented overstock, the acceptance can be communicated to node 102 in a variety of ways. For example, the overstock inventory that is communicated from the EPM 108 to node 104 via data receipt means 112 may have the contact information for node 102. This being the case, node 104 will contact node 102 and request the overstock inventory.

Preferably, however, the EPM 108 will perform the transaction. In this instance, node 104 communicates to EPM 108 that an overstock inventory is accepted. EPM 108, in turn, communicates this acceptance to node 102.

Other aspects of the transaction, such as payment to node 102 by node 104 for the overstock inventory, shipment notice, and receipt of goods notice, for example, can all be handled by EPM 108.

An additional feature of the described inventory transaction that can be handled by communication means 108 is managing authorized users. Many companies, particularly companies with undisclosed intellectual property, prefer that their merchandise is not sold by certain companies. Typically, such companies are those which do not comply with confidentiality measures established to ensure the integrity of a part. To prevent a compromise of a part using the current invention IMS 100, EPM 108 can require that the nodes 101 present authorization before a query into a certain inventory will produce any results. In the alternative, company may also to prevent a compromise of a part by requiring the buyer to agree not to take steps to reverse engineer a newly acquired part. In this situation, node 102, having an overstock of an inventory will input the technical specifications to IMS 100 using communication means 106. Node 104, having an understock of an inventory will query IMS 100 using communication means 106. The inventory in this example is high end inventory and the company only wants exclusive companies to sell this inventory. Before the overstock inventory is communicated to node 104, node 104 must qualify as an authorized company of this inventory. Identification numbers and passwords are one means for determining authorization, but this is just one example and others are readily apparent to those of ordinary skill in the art.

The invention is further described by these following examples. In the examples, the node is a company, though it could be any entity that deals with inventory, from the manufacturer to the retailer. Also, for simplicity, the invention is described using a computer as the communication means and the comparison means is likewise in silico. Variations to these examples are well within the skills of those ordinarily skilled in the art. These variations are well within the spirit of this current invention.

In FIG. 1, there is shown a series of four nodes, 12, 14, 16 and 18 comprising at least two nodes 101, and an exchange processing means 108. The nodes 101 are in contact with the EPM 108 via communication means 106, which comprises data input means 110 and data retrieval means 112.

In this example, IMS 100 is an internet website for a particular product line or product category. There are many possible product lines and categories to which the invention properly applies, and each has its own characteristics and jargon that distinguish it from others. To facilitate understanding only, but not to exclude other applications, the invention will be discussed as it applies to the electronic parts business. Thus, the nodes 101 are companies in the electronic parts industry.

It is also preferred in this example that all inventories managed by the IMS 100 are uniquely identified as to technical specification including. As discussed above, the technical specifications allow the nodes 101 to readily conduct transactions in accordance with vendor-standard part numbers, part number equivalents, and custom part numbers.

The example uses a website communication, but that does not exclude the potential of using other communication and information management mechanisms.

### EXAMPLE

At least two nodes 101 comprises, in this example, four nodes, 12, 14, 16 and 18. Each of the at least two nodes 101 have overstock and understock. Each of the nodes 101 communicates their overstock and understock to the IMS 100 using a communication means 106, typically a computer connected to the internet and addressed to the IMS 100 website. In this example, IMS 100 is an internet based system, so the communication means 106 is a computer and monitor. Each node 101 identifies its overstock to the EPM 108 via the computer/monitor communication means 106. The EPM 108 is a software engine with the ability to cross-reference part numbers to vendor specification tables, reducing the data to a standard format.

Node 12 has a surplus of 150 Power RF Amplifiers. Node 16 has a corresponding deficit, but neither knows of the other and they are at least 1000 miles apart. Both are aware of the IMS 100 online.

Node 12 enters the IMS 100 website, registers, and goes through a semi-automated qualification process (or was prequalified by previous activity). This optional step is referred to as the authentication process and is useful for managing the nodes when the inventory is designated to be sold only by approved companies. For example, parts with technical specifications that could disclose confidential intellectual property are frequently prohibited from being sold to competitors. Because it is desirous to prevent the shipment of overstocked inventory of this type to an unauthorized company, the current invention is optionally equipped with a function for maintaining transactions only between authorized nodes. Node 12 communicates the overstock and understock of electronic parts to EPM 108 using the computer and monitor communication means connect to the internet. The overstock and understock inventory are reduced from a custom part number to technical specifications. These technical specifications are presented to the IMS 100 in detail. In FIG. 2, the node 12 sell listing 13 shows technical specifications of understock goods, including: category 13.1, subcategory 13.2, vendor 13.3, part number 13.4, and basic specifications 13.5. In addition, the quantity 13.6 for each inventory item is listed.

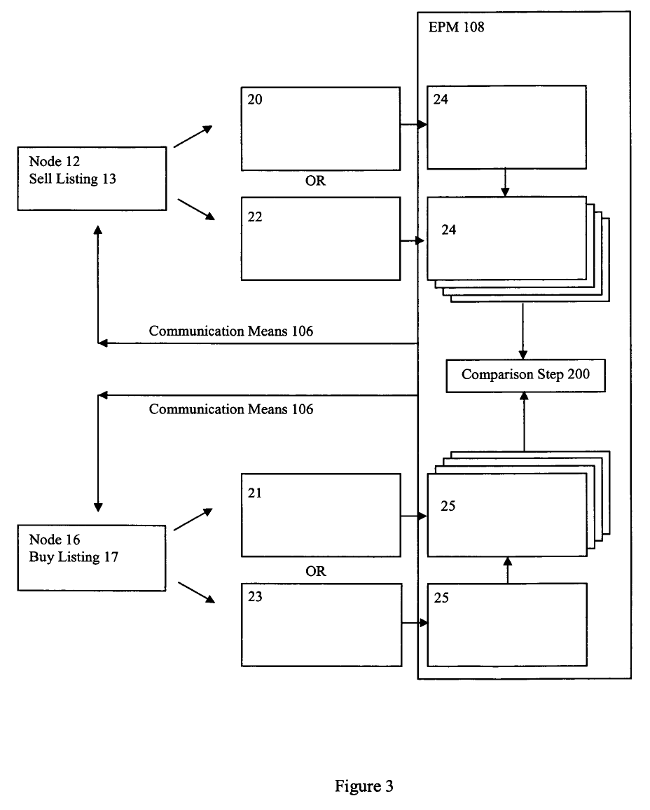

Node 16 also enters the IMS 100 website, qualifies (or was prequalified by previous activity), and lists various overstock and understock technical specifications and corresponding quantities. In FIG. 2, the node 16 buy listing 17 shows technical specifications of overstock goods, including: category 13.1, subcategory 13.2, vendor 13.3, part number 13.4, and basic specifications 13.5. In addition, the quantity 13.6 for each inventory item is listed. In FIG. 3, the software creates a technical specification table using this entered data. In the alternative, the at least two nodes can enter the vendor-standard part numbers of part number equivalents. The software can use these part numbers to develop technical specification tables. The technical specification tables are stored in a database. As shown in FIG. 3, the software behind the IMS 100 website, which comprises EPM 108 compares the technical specifications tables and finds the tentative match between node 12 and node 16.

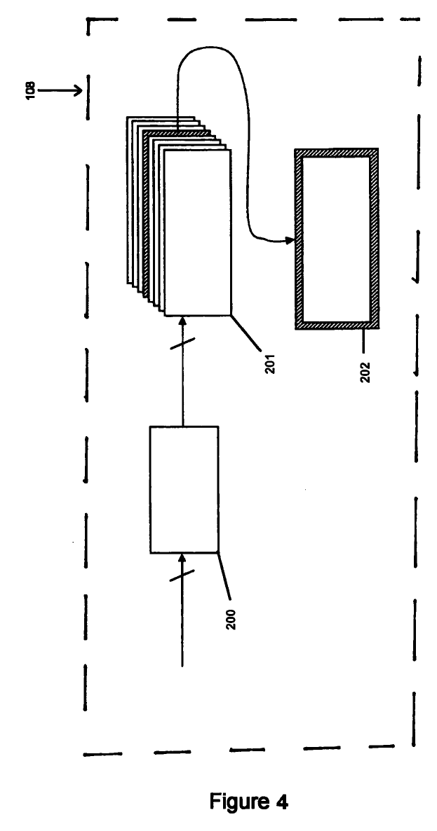

FIG. 4 EPM 108 compares all technical specifications entered and connects complementary overstock technical specifications with understock technical specifications. This step is labeled comparison step 200. In the current example, node 12 has an overstock of Power RF Amplifiers and node 16 has a complementary understock. This example shows a simple complementary match; however, given the volume of inventory that will be provided by numerous nodes using the invention system, complementary matching can be more extensive and difficult.

For example, supposing that a first node has an overstock of 10000 units of inventory and both a second node and a third node have an understock of this same inventory; second node being understocked by 5000 units and third node being understocked by 15000 units. All three nodes are using the current invention system. It is more efficient for the first node to send the 10000 units of overstock inventory to a single location, thereby reducing costs of shipping and preparing for shipping and etc. So, in this scenario, the invention system takes into account that the better complimentary match is the first node with the third node, than the first node with the second node, remainder to the third node. This and other such efficiencies comprise part of the EPM 108 in an alternative embodiment.

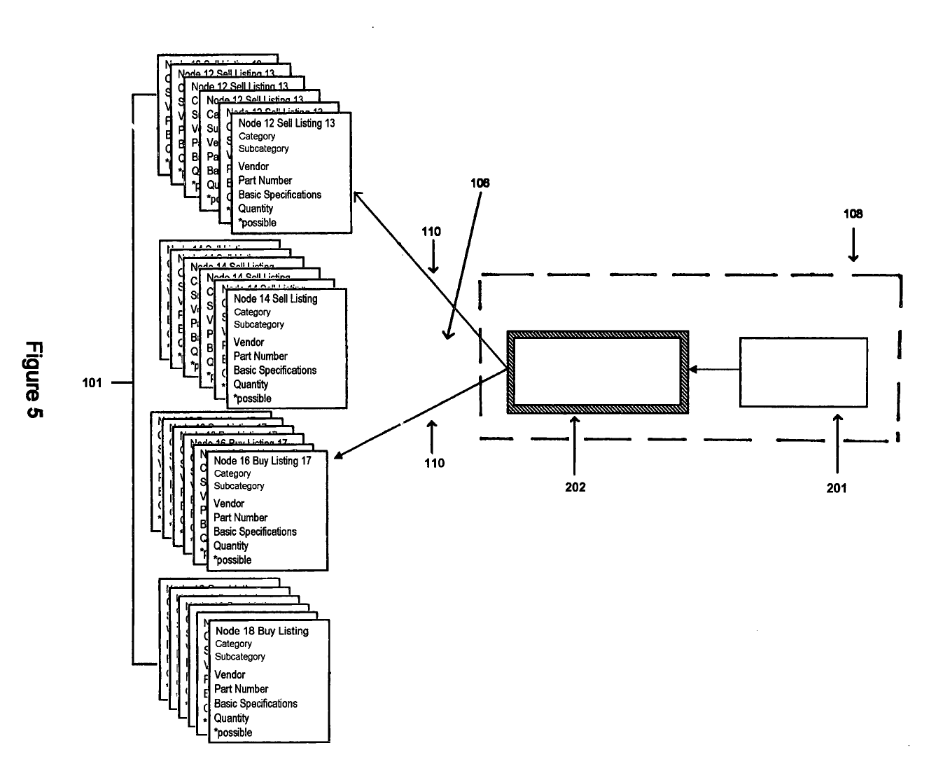

Comparison step 200 generates complementary matches 202 and presents match report 204, which is the complementary match that will be communicated back to the nodes 101. The confidentiality means 203 prevents disclosure of pre-determined technical specifications by the at least two nodes. In addition, the confidentiality means prevents the disclosure of the association between the at least two nodes and parts sold or bought. This prevention of technical specification disclosure and association disclosure prevents a compromise of company-confidential information. FIG. 5 illustrates match report 204 being generated from complementary match 202. The communicating means 106 sends the non-confidential complementary match report 204 to node 12 and node 16.

In FIG. 5, the complementary match 202 generates match report 204. Match report 204 can be selected from the group of complementary matches 202 based on one or more of a variety of factors, including, first to match, best fit, date since technical specification upload and others. Those ordinarily skilled in the art will employ these factors for generating match reports 204 that best suit any particular set of nodes, inventory and desired goals using this current invention. Use of these various factors is well within the spirit of the current invention. Match report 204 is communicated to node 12 and node 16 using communication means 106, which in this embodiment is a computer and monitor. Communication can also occur in a variety of ways, for example, node 16 having the understock can be notified first, and if node 16 decides to accept the overstock inventory of node 12, then node 16 can communicate acceptance to the IMS 100 system. The communicated acceptance is in turn communicated to node 12. Should node 16 decide to reject the overstock inventory of node 12, then node 12 is not notified of the solicitation, and IMS 100 will communicate a match report 204 to the next best fitting node as held in complimentary match 202. Node 16 can accept or reject the inventory presented in match report 204, thus completing the inventory management using the IMS 100.

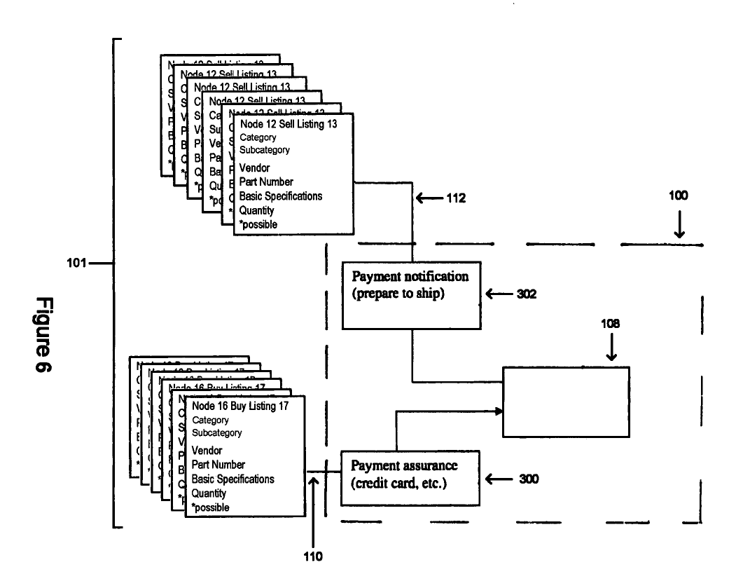

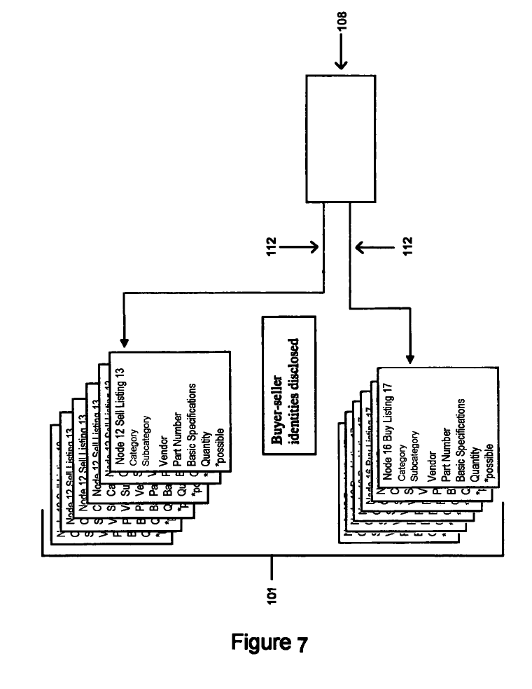

FIG. 6 illustrates an alternative embodiment wherein the IMS 100 also facilitates payment for and shipment of the inventory between two nodes. Again, node 12 has an overstock and node 16 has an understock, and node 16 has accepted the overstock inventory from node 12. In this alternative embodiment, node 16 can accept the node 12 overstock by submitting payment 300. Payment submission 300 is preferably by credit card, but can be any payment method, including, but not limited to wire transfer, check, credit card, charge against PayPal or similar, charge against BMP account, etc. The payment submission 300 is transmitted to the EPM 108 of IMS 100 using communication means 106, which is preferably a computer and monitor with access to the internet. EPM 108 then communicates payment notification 302 to node 12, thereby instructing node 12 to ship the inventory. As shown in FIG. 7, identities of nodes 12 and 16 are revealed to each other during the payment/shipment process. Alternatively, the identities may be permanently maintained by confidentiality means to facilitate transactions between what would otherwise be competitors.

In an alternative embodiment of the payment transaction, the IMS 100 does not facilitate the entire payment from node 16 to node 12 for the inventory exchange, but rather only directly accepts a commission payment. Payment for the inventory, in this case, is made directly from node 16 to node 12. The only role of the IMS 100 for the inventory payment transaction is to provide payment information between the nodes, but not actually receive the payment itself. This arrangement removes the IMS 100 from the payment transaction. IMS 100, therefore, is only directly receiving the commission payment and is only liable for credit card fees on that commission payment, rather than the credit card fees on the commission payment and inventory purchase price.

It is preferred, but not necessary, that the identities of the nodes 101 using IMS 100 are kept private by IMS 101 until after the transaction is secured. Alternatively the identities may be permanently maintained by use of a broker and/or a central bonded and anonymizing fulfillment service. Privacy achieves many objectives, including preventing nodes from using the system to scan for inventory and then arranging transactions directly. Such direct transactions result in loss of profit for the manager of the IMS 100 system. This is because the manager of the IMS 100 system will likely receive a payment for administering the transaction. So, in this case, the identities of nodes 101 are kept private so that the IMS 100 manager can realize a business objective. Still, this is only a preferred embodiment, and embodiments where the nodes' identities are public is also possible. In this type of a situation, for example, the nodes 101 may pay a membership fee to browse, and list inventory on IMS 100. Further still, this public identity situation may apply when the manager of the IMS 100 is part of a single business entity managing inventory within satellite business units, which comprise the nodes 101. Varieties of other possibilities exist for the ordinary practitioner in the art.

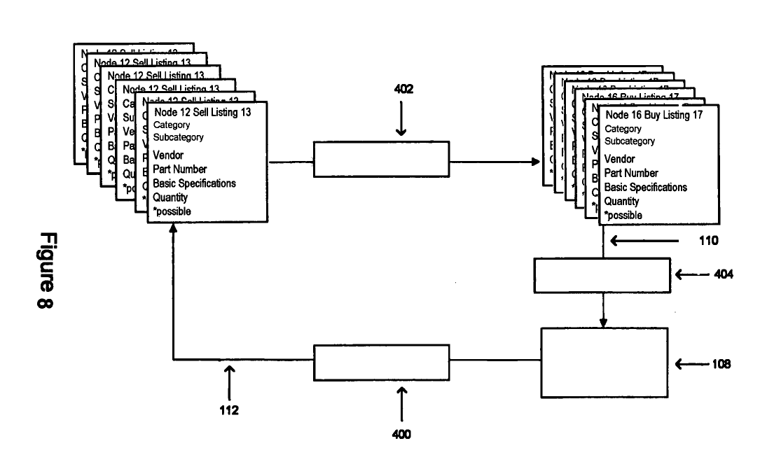

In a preferred embodiment of the current invention, FIG. 8, there is also provided the additional feature wherein IMS 100 holds the payment received from node 16 for the overstock inventory of node 12 until node 16 reports via communication means 106 that the overstock merchandise has been received. In this embodiment, IMS 100 has notified node 12 that node 16 is interested in the overstock for Power RF Amplifiers. IMS 100 also notifies node 12 that node 16 has submitted payment for the overstock inventory by communicating to node 12 a payment notice 400. In a preferred embodiment, IMS 100 has also assured that the payment from node 16 clears (e.g., sufficient funds). Node 12 will then ship the overstock inventory 402 to node 16 using common shipping means. Once the overstock inventory is received by node 16, then node 16 will submit a shipment received report 404 to IMS 100, which in turn releases the funds to node 12. At node 12's option, the payment can be received by check or can remain with IMS 100 as a credit towards future purchases of overstock inventory from another node 101.

In a particularly preferred embodiment, once a match is made by EPM 108 of IMS 100 and communicated to, and accepted by two nodes, e.g., node 12 and node 16, the nodes are put in direct contact through to complete the transaction through IMS 100. In one particularly preferred embodiment, the two nodes are put in email communication facilitated by IMS 100 and EPM 108 to complete the transaction. In an alternative particularly preferred embodiment, the two nodes are placed into a temporary private webpage by IMS 100 wherein the parties to the two nodes, e.g., node 12 and node 16 can complete their negotiations and finalize the transaction. In either instance, it is preferred that the identities of nodes 12 and 16 are withheld until payment is made. For example, once the buyer and seller node have agreed upon the price and shipment terms for the mis-stocked inventory, the seller node pays a commission to the manager of the IMS 100, typically through the use of a credit card or other payment means. Upon receipt of the payment, the IMS 100 releases the identities of each node, so that the transaction can be finally completed and the inventory shipped to the buyer node.

Alternatively, in this embodiment wherein IMS 100 acts to hold payment to assure that each node is meeting its end of the transaction, IMS 100 may charge an additional fee to one or both of the nodes 12 and 16 to cover any credit card fee for the cost of the inventory. However, this alternative embodiment is optional.

At the end of the transaction, node 12 has fewer frequency synthesizer integrated circuits which were not selling in node 12's market and has cash available with which to order merchandise with a higher likelihood of selling. Node 16 has more goods which will sell in node 16's market. Preferably, the IMS 100 manager has earned a fee for facilitating the transfer.

Those ordinarily skilled in the art will immediately recognize the versatility of the current invention and will apply the invention inventory management system to a variety of different inventory items. The inventory items may vary from the shoes of the current example without departing form this disclosed invention. Similarly, the methods for practicing this invention and the means for accomplishing these method steps are versatile. Steps may present in different order, or may be omitted. Additional steps may be added to the method steps presented. These variations are well within the spirit of the current invention.

I claim:

1. An in silico enabled inventory management system, the system comprising:
(a) at least two nodes;
(b) a communication means, comprising
1) a confidentiality means;
(c) an exchange processing means, comprising
1) an inventory data storage means; and
2) an inventory data comparison means, wherein the nodes communicate an inventory data to the inventory management system, and the communicated inventory data is compared by the exchange processing means for compatibility and compatible matches are communicated back to the nodes.

2. The system of claim 1 wherein the at least two nodes are businesses dealing with inventory and having mis-stock of inventory.

3. The system of claim 2 wherein each of the at least two nodes comprises retailers, suppliers, manufacturers, distributors, corporations or companies.

4. The system of claim 3 wherein each of the at least two nodes comprises companies.

5. The system of claim 1 wherein the communication means is a means selected from the group consisting of a computer and monitor, a telephone, a facsimile machine and combinations thereof.

6. The system of claim 5 wherein the communication means is a computer and monitor linked to the internet.

7. The system of claim 5 wherein the communication means further comprises a data input means and a data receipt means.

8. The system of claim 7 wherein the data input means comprises a computer keyboard, a microphone or a scanner and the data receipt means comprises a computer monitor, a speaker or a printer.

9. The system of claim 5 wherein the communication means employed by one of the nodes of at least two nodes is a different communication means than is employed by another node of the at least two nodes.

10. The system of claim 1 wherein the exchange processing means further comprises a manual, automated, or semi-automated process.

11. The system of claim 10 wherein the exchange processing means is an online website.

12. The system of claim 1 wherein the at least two nodes communicate inventory data to the exchange processing means.

13. The system of claim 12 wherein the at least two nodes communicates a stock keeping unit as the inventory data to the exchange processing means.

14. The system of claim 12 wherein the at least two nodes communicates to the exchange processing means using vendor-standard part numbers, part number equivalents, custom part numbers, or technical specifications.

15. The system of claim 1 wherein the inventory data comparison means converts vendor-standard part numbers, part number equivalents, or custom part numbers to technical specifications.

16. The system of claim 1 wherein the exchange processing means communicates to the at least two nodes vendor-standard part numbers, part number equivalents, custom part numbers, or technical specifications.

17. The system of claim 1 wherein the confidentiality means prevents the communication of confidential information between the at least two nodes.

18. The system of claim 1 wherein the confidentiality means prevents the communication of pre-determined specified functions between the exchange processing means and the at least two nodes.

19. The system of claim 1 wherein the confidentiality means prevents the communication between the at least two nodes regarding an association between potential sellers and the parts they offer for sale.

20. The system of claim 1 wherein the confidentiality means prevents the communication between the at least two nodes regarding an association between potential buyers and the requirements they offer to buy.

21. The system of claim 1 wherein the confidentiality means protects the identities of the at least two nodes by providing a central bonded and anonymizing fulfillment service.

22. The system of claim 1 wherein the exchange processing means further comprises a complementary match ranking function for communicating the most relevant complementary match to at least one node of the at least two nodes.

23. The system of claim 1 wherein the exchange processing means further comprises a transaction management function for orchestrating payment and inventory shipping by and between the at least two nodes determined to have complementary matching inventory.

24. The system of claim 1 wherein the identity of the nodes of the at least two nodes is withheld.

25. The system of claim 1 wherein the nodes of the at least two nodes are authorized to deal with the inventory.

26. A method for managing inventory using the system of claim 1 comprising:
(a) a means to communicate inventory data from the at least two nodes to the inventory management system,
(b) a means to compare the communicated inventory data by the exchange processing means,
(c) a means to communicate compatible matches to the at least two nodes.

27. An in silico implemented method of managing inventory comprising the steps of:
(a) providing at least two nodes;
(b) communicating mis-stocked inventory data to an inventory management system;
(c) comparing inventory data communicated by the at least two nodes using the inventory management system;
(d) communicating non-confidential complimentarily matched inventory data to the at least two nodes by the inventory management system.

28. The inventory management method of claim 27 further comprising the step of:
(a) facilitating a transaction between the at least two nodes that have been determined to have complementarily matching mis-stocked inventory data using the inventory management system.

29. The inventory management method of claim 27 further comprising the step of:
(a) managing the nodes of at least two nodes using the inventory management system.

30. The inventory management method of claim 29 wherein the step of managing the nodes comprises maintaining the identity of the nodes in private.

31. The inventory management method of claim 29 wherein the step of managing the nodes comprises authenticating the node.

32. The inventory management method of claim 27 wherein the nodes of the at least two nodes are businesses dealing with inventory and having mis-stock of a particular inventory.

33. The inventory management method of claim 32 wherein the step of communicating mis-stocked inventory data between the at least two nodes and the inventory management system uses a communication means comprising a computer and monitor, a telephone, a facsimile and combinations thereof.

34. The inventory management method of claim 33 wherein the step of communicating uses a computer and monitor connected to the internet.

35. The inventory management method of claim 27 wherein the step of communicating mis-stocked inventory data to the inventory management system uses vendor-standard part numbers, part number equivalents, custom part numbers and technical specifications to identify the inventory.

36. The inventory management method of claim 35 wherein the step of communicating mis-stocked inventory data to the inventory management system uses a stock keeping unit to identify the inventory.

37. The inventory management method of claim 27 wherein the step of comparing inventory data further comprises a function for ranking complementarily matched inventory data.

38. The inventory management method of claim 27 wherein the step of comparing inventory data further comprises a function for converting vendor-standard part numbers, part number equivalents, and custom part numbers to technical specifications.

39. The inventory management method of claim 27 wherein the step of communicating complimentary matched data between the inventory management system and the at least two nodes comprises a telephone, a computer and monitor, a facsimile and combinations thereof.

40. The inventory management method of claim 39 wherein the step of communicating uses a computer and monitor connected to the internet.

41. The inventory management method of claim 27 wherein the step of communicating non-confidential mis-stocked inventory data from the inventory management system to the at least two nodes uses vendor-standard part numbers, part number equivalents, custom part numbers and technical specifications to identify the inventory.

42. The inventory management method of claim 27 wherein the step of communicating non-confidential complimentarily matched inventory data to the at least two nodes by the inventory management system further comprises a function to disclose all or part of the separate usable functions.

43. The inventory management method of claim 27 wherein the step of communicating non-confidential complimentarily matched inventory data to the at least two nodes by the inventory management system further comprises a function to insulate potential sellers from the parts they offer for sale.

44. The inventory management method of claim 27 wherein the step of communicating non-confidential complimentarily matched inventory data to the at least two nodes by the inventory management system further comprises a function to insulate potential buyers from the parts the requirements they offer to buy.

45. The inventory management method of claim 27 wherein the step of communicating non-confidential complimentarily matched inventory data to the at least two nodes by the inventory management system further comprises a function to provide a central bonded and anonymizing fulfillment service.

46. An internet based inventory management method comprising the steps of:
(a) having at least two retailers in the electronic retail business connected to an inventory management system;
(b) communicating mis-stock of electronic parts inventory to the inventory management system using a computer and monitor that accesses the inventory management system via the internet;
(c) comparing the communicated mis-stock of electronic parts inventory to determine complementarily matched mis-stock of shoe inventory; and
(d) communicating the non-confidential complementarily matched mis-stock of electronic parts inventory to the corresponding retailers of the at least two retailers using the internet.
